(19) United States
(12) Patent Application Publication
(10) Pub. No.: US 2007/0158174 A1
(43) Pub. Date: Jul. 12, 2007

(54) Energy management in a power generation plant

(75) Inventors: Ben Zion Livneh, Johannesburg (ZA); Eli Barnea, Haifa (IL); Isaac Yaniv, Haifa (IL)

Correspondence Address: Gary M. Nath;THE NATH LAW GROUP, 112 S. West Street, Alexandria, VA, 22314, US

(73) Assignee: MicroCoal Inc.

(21) Appl. No.: 11/702,054

(22) Filed: Feb. 5, 2007

Related U.S. Application Data
(63) Continuation-in-part of application No. PCT/IL04/01077, filed on Nov. 24, 2004.

(30) Foreign Application Priority Data
Aug. 5, 2004 (ZA) 2004/6277

(51) Int. Cl. A62D 3/00

(52) U.S. Cl. 204/157.43; 422/186

(57) ABSTRACT

Method for managing electric power generated during periods of low demand, in an electric power market where consumption of electric power exhibits periods of different demands. The method includes upgrading solid fossil fuel by electromagnetic radiation (EMR) upgrading during the periods of low demand, storing and utilization of the upgraded fuel. Fuel utilization may include burning for electric power generation during periods of high demand, burning in another heat-consuming industrial process, or trading the fuel with another business entity. The EMR upgrading used in the method includes reducing the inherent moisture content in the upgraded fossil fuel at least in half.

### FIELD OF THE INVENTION

This invention relates to energy management methods in utilities burning solid fossil fuel.

### BACKGROUND OF THE INVENTION

Power-producing utilities struggle with uneven demand for electricity during each daily cycle. During one-day period, demand changes on an hourly basis, with peak demand periods typically in the morning and evening and low demand during the night. The gap between the high demand and low demand levels can reach over 30% of the high demand level. Since electricity is a commodity that cannot be stored in its raw form, a great deal of a utility's generation capacity is not efficiently utilized. In addition, frequent large fluctuations in generation levels are costly in terms of operating costs and mechanical wear, particularly in power plants burning solid fossil fuel such as coal.

Electric power utilities burning fossil fuel are operating a process that converts heat contained in the fuel to steam, which then drives a turbine that generates electricity. A coal-fired utility process contains coal handling and coal preparation units, boilers with burners, ash and emission treatment units, turbine and generation related facilities, water treatment units and auxiliaries.

The coal handling and preparation systems include off-loading facilities for trains, barges or other transportation means, coal stockyard which typically stores coal for 1.5-2 months production, materials handling facilities to drive coal from the stockyard to the plant, coal feeders, pulverization plant and feeding facilities to the boilers' burners.

Coal-fired power generation plants are expensive and complex to operate with very slow process dynamics. A coal-fired power plant requires many hours of preparation before generation of electricity can commence, making it uneconomical to switch off during low demand periods. At the same time, power generation units must be tightly synchronized with their load for plant integrity and operation safety considerations. If the demand is reduced to a level below a critical value, coal fuel alone cannot sufficiently maintain the necessary thermal conditions of the boiler, and other fuels such as diesel must be used together with coal to keep the boiler at the appropriate conditions. This is an undesired condition that increases operating expense.

To reduce the gap in load between high demand and low demand periods in order to even out demands, utilities implement an aggressive time-of-use pricing strategy to encourage customers to reduce consumption during high demand periods and to increase consumption during low demand periods. Although the price for electricity in high-demand periods may be several times the price for electricity in a low-demand period, this strategy alone is not always sufficient to bridge the demand gap.

Many different solutions have been proposed to store excess electricity generated during low-demand periods for use during high-demand periods. Among the solutions that have been proposed is pumping water to high elevations during low demand and the use of this water in reverse to power hydroelectric units during high-demand periods. This method is known as “pumped storage” and is used in a few locations around the world including the USA. Pumped storage requires large capital costs and has a large impact on the environment.

U.S. Pat. No. 3,631,673 suggests accumulating energy in off-peak hours by storing compressed air. In peak hours, the compressed air drives a gas turbine. U.S. Pat. No. 5,491,969 suggests that the compressed air is used for combusting fuel in a gas turbine (regular compressors are then switched off). U.S. Pat. No. 3,849,662 discloses a power plant burning coal gas obtained by coal gasification, in a steam turbine. Coal gas produced during off-peak hours is stored in a pressurized holder and is burnt in a gas turbine during peak hours.

Over 30% of electric power in the US is generated from coal. Coal production in the US is 1.1 billion short tons per year. More than 90% of this coal is used for generating electricity. America has coal reserves which will last for 250 years at the current consumption levels.

The quality of coal can be assessed in terms of various attributes such as heat value, moisture content, volatile matter content, ash content, and sulfur content. Each attribute, to a greater or lesser extent, affects the manner in which the coal is used, its burning characteristics and hence its economic value. These attributes vary from coal deposit to coal deposit and moreover, within a given deposit, the characteristics of the coal can vary substantially.

Deposits, such as those encountered in the Powder River Basin (PRB) in the states of Wyoming and Montana, as well as in other similar deposits throughout the world, contain coal which is commonly known as “low rank” coal. Low rank coal includes sub-bituminous and lignite coals and is also known as brown coal. The water content of these coals is considerable, and reaches levels of well over 30%.

In connection with moisture content of coal, the following definitions and standard methods set forth by the American Society for Testing and Materials (ASTM) will be relied on in the present application.

Total moisture means the measure of weight loss in an air atmosphere under rigidly controlled conditions of temperature, time and air flow, as determined according to either § 870.19(a) or § 870.20(a), incorporated herein by reference;

Inherent moisture means moisture that exists as an integral part of the coal seam in its natural state, including water in pores, but excluding that present in macroscopically visible fractures, as determined;

Excess moisture means the difference between total moisture and inherent moisture, calculated according to § 870.19 for high-rank coals or according to § 870.20 for low-rank coals, both incorporated herein by reference. “Excessive moisture” will be referred to in the present application as “surface moisture”;

Low-rank coals means sub-bituminous C and lignite coals;

High-rank coals means anthracite, bituminous, and sub-bituminous A and B coals.

Laboratory procedure for estimation of inherent moisture is outlined in ASTM D1412-93 incorporated herein by reference. Collection of coal samples for the estimation is also determined in ASTM documents.

In brief, the laboratory procedure is as follows. The coal is ground to fine powder, and exposed to the open air for a certain period of time so that the surface moisture of the coal is mostly dried, and the residual surface moisture of the coal equals the ambient moisture. The assumption is that the residual moisture in the coal is inherent moisture. Coal is then heated in an oven and the inherent moisture content is calculated from the loss in mass.

There are two distinct types of moisture in coal: surface moisture and inherent moisture. Surface moisture is the water contained in a coal particle that may be the result of wetting the coal by physically pouring water on it under normal conditions, such as in the case of rain or spraying systems. Exposing the coal particle to a source of heat such as the sun or a flow of hot gases or physical drying mechanisms such as centrifugals, can drive this moisture off.

Inherent moisture is the water that is locked inside the coal particle, mostly since its formation, or which penetrated the coal particle in a process that takes a long period of time and high pressure. Inherent moisture is typically locked in the coal particle in capillaries or is chemically bounded to the coal and is impossible to drive out by processes which are used for drying Surface moisture, unless more extreme forces are used in the form of high temperature and/or high pressure.

Traditional coal dewatering or drying processes for inherent moisture are complex and are conducted in extreme conditions. Most of these processes are based on a technique in which coal particles are heated by conventional heating and pressure is introduced or built in the system. The combined force in the process expels the inherent moisture from the coal particles. The final moisture content of coal treated in this type of process is mostly dependent on the ambient conditions prevailing inside the process. The end result is that drying inherent moisture in coal to low levels requires a great deal of energy and a long residence time of the coal in the drying process.

Existing dewatering techniques make use of conventional heat transfer processes to evaporate the water off the coal particles. A disadvantage of these processes is the fact that the coal particles are heated from the outside inwards in order to evaporate the water. Coal is known to be a heat insulator, with a very high resistance for heat transfer that leads to inefficiency, as much heat is wasted on heating each coal particle and its environment, while the temperature gradient must be big enough to overcome the high resistance of the coal particle to heat transfer. Such heating is risky and requires special care, as exposing coal to high temperature can ignite it.

The dewatering process for upgrading of low-rank high inherent moisture coals has historically been faced with two major drawbacks, which limited the deployment of industrial dewatering systems on a large scale. Low-rank upgraded coal produced to date has exhibited low auto-ignition points and spontaneous combustion that occurs faster than in other coals, including low-rank raw coal. It was found in tests that when a pile of dewatered coal is exposed to airflow for a number of hours (typically less than 72 hours), the coal reaches temperatures at which spontaneous combustion or auto-ignition occurs. Spontaneous heating and spontaneous combustion of coal particles have been common problems of high inherent moisture content raw coals, but such events usually occur after longer open-air exposure periods of days and weeks. This phenomenon is aggravated by the dewatering process which substantially increases the surface-area-to-volume ratio, hence making the coal particles more active in absorbing air moisture, further reducing the upgraded coal shelf life.

Another problem observed in dewatering coal is the production of large quantities of coal fines. Each transfer of dried coal after it leaves the process degrades the coal particle size further and produces more coal dust, as dried coal is more brittle. Dried coal does not have the inherent ability to trap small particles on its surfaces like moist coal. This causes dust-size particles to be released and become lost in transportation, and has a high risk of causing fires or explosions.

An article in The Australian Coal Review, October 1999, p. 27, treats dry cleaning of coal, i.e. separation of coal from rejects (rocks) without water floatation. In the dry cleaning process, the moisture content of feed coal should not reach a level where the particles stick together, which is a function of the surface moisture. Thus, a low-rank coal can have quite a high inherent moisture level and still be superficially dry and suitable for dry cleaning. The article suggests that thermal drying can be employed to reduce the surface moisture to a sufficiently low level and recommends conveying the coal on a belt through a microwave dryer. In this type of dryers, water readily absorbs the heat energy and is vaporized while coal is not heated.

U.S. Pat. No. 4,280,033 discloses MW drying apparatus and process for high-grade ground coal for coking or gasification. The apparatus comprises an endless conveyor belt passing through a closed treatment zone, electrode plates at opposite sides of the coal belt, and air blowing system for passing hot air over the belt to remove humidity.

U.S. Pat. No. 4,259,560 discloses MW heating/drying method for conductive powder materials, especially coal before coking. Pulverizing is used to avoid arcing. Moisture content can be regulated in real time by IR detector measurements.

The removal of various contaminants from coal using Electro Magnetic Radiation (EMR) is also a known art. In this regard, reference is made to ‘Mossbauer analysis of the microwave desulphurization process of raw coal’ by S. Weng (1993); ‘Effect of microwave heating on magnetic separation of pyrite’ by Uslu et all (2003); and ‘Microwave embrittlement and desulphurization of coal’ by Marland et all (1998).

### SUMMARY OF THE INVENTION

This invention relates to a novel energy management system and a process for upgrading solid fossil fuel such as coal, for use therein. More particularly it is concerned with a process for storing inexpensive electricity generated during low-demand periods in the form of upgraded coal, for use during high-demand periods when the cost of electricity is a great deal higher.

The invention combines business methods whereby electricity is generated and stored during low-demand periods and used for generating electricity at high prices during high-demand periods, with physical methods allowing such storage.

In the method of the present invention, low cost electricity is consumed during low-demand hours, e.g. in the night, to upgrade low-cost, low-heat value fossil fuel for use as a substitute for high-cost, high-heat value fuel. The upgraded fuel is stored and is used in power generation units throughout the day, particularly during high-demand periods, to generate electricity that is salable in the retail energy market at a considerably higher price.

According to a first aspect of the present invention, there is provided a method for managing electric power generated during periods of low demand, in an electric power market where consumption of electric power exhibits periods of different demands. The method includes upgrading solid fossil fuel by subjecting it to electromagnetic radiation (EMR) during the periods of low demand and utilization of the upgraded fuel. Subjecting said fossil fuel to said EMR results in at least a partial removal from the fossil fuel of moisture and impurities such sulfur (S), iron (Fe), mercury (Hg) and the like.

The utilization preferably includes burning the upgraded fossil fuel for electric power generation at least during periods of high demand. However, it may include also burning the fuel in another heat-consuming industrial process or trading the fuel with another business entity.

The management method is particularly useful for application in a power-generation plant, where the upgrading is performed by means of electric power generated by the same plant. Preferably, the upgraded fossil fuel is stored and burnt also at the same plant, for electric power generation at least during periods of high demand.

Preferably, the quantity of the upgraded and stored fossil fuel produced during low-demand periods covers all fuel consumption for power generation at the same plant during periods of high demand. More preferably, average daily quantity of the upgraded and stored fossil fuel covers at least average daily fuel consumption for power generation at the same plant.

Preferably, the EMR process used in the method includes reducing the inherent moisture content in the upgraded fossil fuel by more that 5%, particularly by more than 30% and yet more particularly by 50% or more.

In accordance with a second aspect of the present invention, there is provided a method of upgrading solid fossil fuel. The method includes dewatering of the solid fossil fuel by EMR, such that the inherent moisture content in the upgraded fossil fuel is reduced at least in half. Daily quantity of upgraded fossil fuel obtained by the electrical dewatering process is commensurate to daily consumption of the power generation plant or/and another industrial process.

The solid fossil fuel may be low-rank coal, oil shale, tar sand, sub-bituminous coal, etc., with high inherent moisture content. However, high-rank coals with initial low inherent moisture can be further dried as low as 1% inherent moisture.

The method may be best performed where electric power consumption due to other consumers exhibits periods of different demands and the electric dewatering process is performed during low-demand periods of the electric power consumption.

Preferably, the EMR process is carried out by using electric power produced by a power generation plant burning the fossil fuel in its upgraded state. More specifically, it is carried out where the power generation plant operates with daily peaks of electric power production and the EMR process is performed predominantly during off-peak hours of the electric power production.

The method includes storing of upgraded fossil fuel obtained during the off-peak hours and using the upgraded fossil fuel for electric power production during the daily peaks. Preferably, the quantity of upgraded fossil fuel obtained during the off-peak hours covers at least daily consumption of the power generation plant or the period between two subsequent low demand periods. This substantially reduces the operating costs of the dewatering process.

The EMR upgrading may be preceded by driving off surface moisture from said fossil fuel by means of hot gases.

Preferably, the EMR upgrading is performed by means of microwave radiation.

The method of the present invention in particular provides dewatering and upgrading low-grade solid fossil fuels at low temperatures and pressures by means of electromagnetic radiation. This method requires short start up and shutdown periods suitable for interruptible operation during short periods, and has a small footprint that allows the method to be deployed inside or alongside the power plant. The use of this method for upgrading low-rank coal during low demand periods to produce the next day's demand for coal can save utilities millions of Dollars a year in fuel costs.

The physical dewatering process is based on exposing the solid fossil fuel to high frequency electromagnetic radiation. There are many benefits of a radiation-based dewatering process over other processes. Radiation dewatering is performed at atmospheric pressure and does not require heating the fuel particle itself. The start-up procedure of the process and its shutdown are quick, making the process suitable for non-continuous and interruptible operations constrained by the need to utilize low-cost electricity. Furthermore, radiation can be more efficient than other techniques in that the dewatering of fuel particles does not require the complete evaporation of the water, as some of the water may be driven off the fuel particles mechanically.

Unlike existing inherent moisture dewatering processes involving extreme heat and pressure conditions, which require large spaces and are normally deployed near the source of the fuel, the method of the invention can be implemented with a small footprint, it is quiet, environmentally friendly and is simple to operate, making it suitable for both sides of the fuel's value chain—the source side as well as the utility's side.

One fundamental premise of the process is subjecting the fuel particles to electromagnetic radiation at radio, microwave or higher frequencies. The intensity of the radiation i.e. the energy density per unit volume of fuel and the frequency of the radiation may be varied according to requirements, taking into account all relevant factors. Another important premise of the process is the use of cheap electricity during low demand periods to dewater and upgrade the fuel that is used to produce more expensive electricity throughout the day, in particular during high demand periods. This introduces to the utilities an innovative means by which electricity can be generated and stored inside the fuel during low demand periods to be used during high demand periods to produce higher revenues.

When the process is deployed near a utility's power generation unit, it becomes possible to a large extent to integrate the process with the utility's existing fuel handling facilities, hence saving large capital expenses. In this case, the process of dewatering is carried out in a stage prior to a pulverizing unit which mills the fuel solids to powder before feeding the powder to the boiler's burners. In such a case, the low-grade fuel may be drawn from a stockyard by means of conventional and existing material handling facilities. The fuel may then be dried by means of conventional heat i.e. a stream of hot gases, and then passed through the radiation units. Dewatered (upgraded) fuel may be stored for later use, or may flow directly from the radiation units into the existing pulverization unit. Normal power plant operation processes can then proceed.

When the upgraded fuel is stored for later use, existing or new enclosed storage facilities may be used, such as bins or silos or any other confined dry material storage unit. This fuel can be then fed directly to the pulverization unit, and re-enter the normal power plant processes. Keeping the upgraded fuel in a confined storage environment and under controlled conditions extends its shelf life and reduces the risks of undesired ignition. The accumulated fuel may be stored in silos, bins or any other means of storage. During the storage period the storage facilities may be purged with inert gases such as nitrogen or carbon dioxide, to prevent the fuel and fines from combusting.

Prior to subjecting the low-grade solid fuel to radiation, it may be sized. This could be done in any appropriate way, for example by grading or milling. Further particle sizing is performed during the pulverizing step which takes place after the dewatering process and prior to the fuel being fed to the burner. Subjecting fossil fuel to EMR produces fines and the radiated fuel exhibits brittle characteristics which may prove to be beneficial in the pulverizing unit.

The method of present invention allows the fossil fuel to be upgraded close to the place of its consumption, both in space and in time, so that the dried fossil fuel does not need much additional handling such as transportation. Immediately following the EMR upgrading, the fuel may undergo a further size reduction process of pulverizing. Thus coal fines are not lost in transportation and the risk of causing fires and explosions is diminished.

The fuel could be processed in batches but preferably is processed on a semi-continuous or continuous basis. Thus the fuel may be transported through or past one or more sources of electromagnetic radiation on appropriate transport devices. Such devices are preferably inert to electromagnetic radiation.

Any appropriate material may be used for the transport devices and for example use may be made of conveyors or other transport devices which are made from materials, e.g. ceramic or stainless steel material, which are inert to radiation. This ensures that no energy is wasted unnecessarily to heat up elements of the process which do not contribute to the main objective of driving the locked moisture out of the fuel particles.

The fuel may be subjected to the radiation in one or more stages. The electromagnetic radiation at the appropriate frequency excites the water molecules locked inside the fuel particles, and consequently increases the water's temperature so that the water is driven out and is released from the fuel. This, in turn, may raise the temperature of the fuel particles. Higher water temperature reduces surface tension effects so that the forces that lock the water inside the capillaries in the fuel particles are reduced and the dewatering process becomes more efficient.

It is also possible to vary the physical characteristics of each stage. For example at least in one stage the fuel may be subjected to electromagnetic radiation in the presence of a suitable inert gas, such as nitrogen or carbon dioxide, which acts as an ignition suppression agent to prevent it from burning and suppresses conditions which may be developed and could lead to explosion. This gas could also heat the processed fuel to dry off its surface moisture which may be originally contained in the fuel or which is built up during the radiation process.

In most cases the water vapour that is released by the radiation process is clean and could be released to the atmosphere.

The fuel may be subjected to a cooling step which will also remove the water vapour, and thereafter dry fuel may be screened and recovered. It may also be required that the dewatered coal particles are kept in certain ambient conditions so as to drive off all excess surface moisture which may accumulate as a result of the radiation.

According to a next aspect of the present invention, there are provided the following systems for practicing the above methods.

A system for energy production by burning solid fossil fuel in a power generation plant including burners comprises an EMR plant for upgrading the solid fossil fuel and transportation means for moving the upgraded solid fossil to the burners. The EMR plant is adapted to reduce inherent moisture content in the upgraded solid fossil fuel by 30% or more. The system preferably comprises storage means suitable to store a quantity of the upgraded solid fossil fuel at least commensurate to daily consumption of the power generation plant.

A system for producing upgraded solid fossil fuel for burning in an industrial process such as power generation, the system comprising an EMR plant adapted to reduce inherent moisture content in the upgraded solid fossil fuel by 30% or more, and storage means suitable to store a quantity of said upgraded solid fossil fuel at least commensurate to daily consumption of the industrial process.

A system for producing upgraded solid fossil fuel, comprising an EMR plant adapted to reduce inherent moisture content in the upgraded solid fossil fuel by 30% or more, the EMR plant being adapted to process one of the following: low-rank coals, oil shale, tar, sand etc.

According to a further aspect of the present invention, there is provided upgraded solid fossil fuel obtained by EMR process by the above described methods or in the above described systems. Our tests show that the upgraded fuel has increased heat value or reduced emissions, while at the same time its economic value increases as well.

### BRIEF DESCRIPTION OF THE DRAWINGS

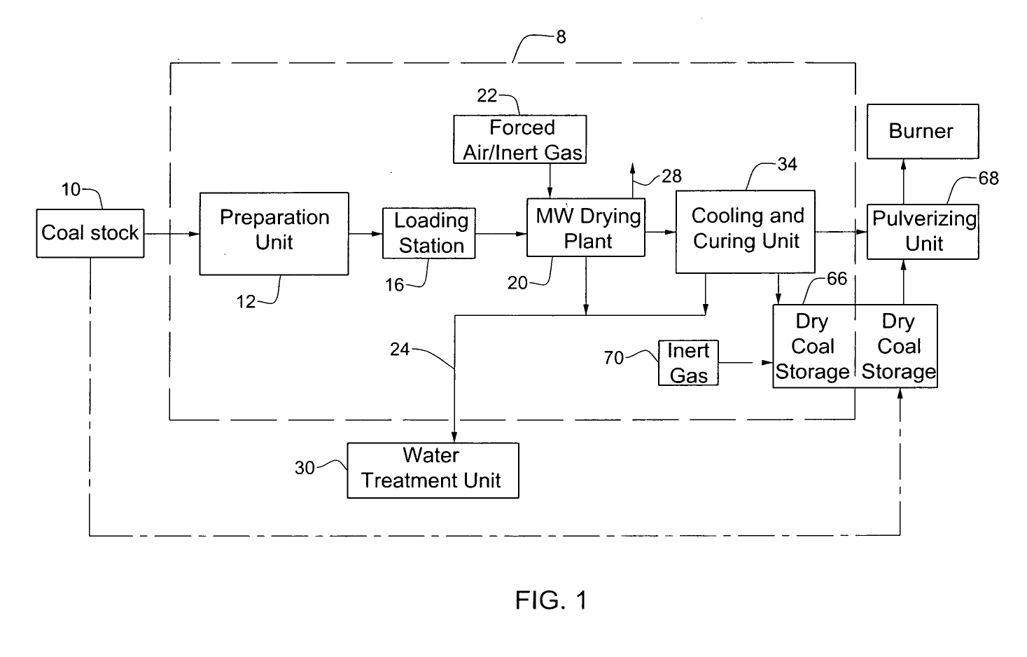

In order to understand the invention and to see how it may be carried out in practice, an embodiment will now be described, by way of non-limiting example only, with reference to the accompanying FIG. 1 which is a schematic diagram of low-rank coal upgrading and utilization according to the method of the present invention.

### DETAILED DESCRIPTION OF THE DRAWING

With reference to FIG. 1, the steps and the components of one example of process and system in accordance with the invention are depicted on the background of the existing process of coal-burning in a power-production utility, as described in the Background of the Invention. For illustration purposes, FIG. 1 shows the process for dewatering coal, but it is similarly suitable for any other solid fossil fuel. The described process is designed to be performed between the coal stockyard and the coal bunkers feeding the pulverization plant.

A production scheme for practicing the process includes the following main components: coal stock 10, coal preparation unit 12, loading station 16, microwave upgrading plant 20, cooling and curing unit 34, upgraded coal storage units 66, pulverizing unit 68, and water treatment plant 30. The other components of the scheme will become clear further on. In this drawing, an enclosed area 8 represents the process of the present invention while the portion lying outside the enclosed area represents the existing process at the utility.

Low-rank wet coal is stored in the stock 10 and is fed using appropriate techniques to the coal preparation unit 12 in which the coal can be sized. If necessary the coal could be graded or milled in any appropriate way.

The coal is then passed to the loading station 16 where the coal is transferred to transport devices (e.g. conveyors) which are transparent to microwave radiation and which can withstand the process temperature without resulting mechanical damage. For example ceramics, plastic or stainless steel materials, which are not heated by microwave radiation and which do not materially attenuate such radiation, can be used in the construction of suitable conveyors (not shown). The loading station 16 uses conventional material handling systems. The design may be different for each specific application, and if a batch or continuous process strategy is deployed. In a batch operation the coal is loaded at a certain profile in the MW plant 20, and the energy required in the process is dependent on the radiation time. In a continuous operation, the coal is moved through the microwave drying plant 20 and the energy required for drying is dependent on the speed of motion.

The microwave drying plant 20 comprises a housing and a number of microwave radiation sources (not shown). The housing is made of special material such as stainless steel and is shielded so that microwave radiation does not escape from the housing, thereby ensuring that the environment is electromagnetically safe, and the released water vapour and gasses are controlled. The housing is also designed to focus the electromagnetic radiation directly onto the coal, so as to maximize the yield of dried coal relatively to the energy input.

MW radiation sources may be made using magnetron or other suitable technology. The radiation frequency of each source and the energy density prevailing in the housing can be varied according to requirements taking into account all relevant circumstances. Similarly, the period for which the coal is subjected to the radiation can be varied taking into account the efficiency of the dewatering process.

Forced air or inert gas such as nitrogen or carbon dioxide, depending on the process conditions, is directed from a source 22 to the plant 20. The injection of forced air or inert gases is used to maintain a low humidity environment inside the housing. Humidity inside the housing is due to the water released from the coal, and due to the low temperature of the process. A substantial amount of water vapour 28 is released from the coal. This water vapour is driven off to the atmosphere by means of the air or inert gases 22 that are injected into the housing.

In the case where an excessive amount of water is released from the coal, water 24 which drains from the unit can be directed to the water treatment plant 30. This process may not be required when the water which is removed from the coal can be released to the environment.

The MW plant 20 may comprise for example a single stage. It also could be made of a plurality of stages depending on the extent of dewatering required, and the amount of coal which is being dewatered.

Multiple MW plant units can be stacked in parallel and in series to each other. Parallel units serve to increase the capacity of the entire process while series units serve to increase the capacity of each line individually.

Dried coal emerging from the plant 20 is directed to the coal cooling and curing unit 34. At this stage, the coal may contain surface moisture which is the result of the inherent moisture driven off by the electromagnetic radiation (see below).

Upgraded coal 64 emerging from the cooling and curing unit 30 can be directed either to the upgraded coal enclosed storage units 66 or to the next stage in the utility's process which will be usually the pulverizing unit 68, preparing the coal for burning.

The storage unit 66 is sized to hold enough upgraded coal to last during a high-load period of power production, when the MW radiation plant is not operational. Inert gases 70 may also be introduced to the enclosed storage units 66 in order to keep the coal under conditions that are not conducive to ignition or fire. As shown by the divisive broken line in FIG. 1, the enclosed storage units 66 may be part of an existing utility structure, or may be specially added to accommodate the upgraded coal produced by the process.

A bypass connection 72 provides for direct connection between the cooling and curing unit 30 and the pulverizing unit 68. The bypass may be operational during low-demand periods of power production.

The mode of operation of the process is such that the coal serves as capacity for storing energy, where cheap electric power is used to upgrade coal that is used during a high demand period. This strategy further benefits the utility in that it keeps the power plant operational at a certain load during low demand periods and hence produces more balanced and stable load characteristics throughout the day and so stabilizes electricity generation. The process also requires relatively short start up and shutdown periods.

To reduce the cost of the energy required for the entire process, the MW plant units should have a process capacity which is sufficient to upgrade the amount of coal required for a whole day's operation in a matter of a few hours when demand for electricity is at its lowest. This requires that the process only works certain hours, and is switched on and off as demand changes throughout the day.

The exemplary process of the present invention departs from the utility's normal process at the coal stockyard 10 and returns to the normal process at the input to the pulverizing unit 68. The confined storage facility 66 is designed to hold coal for high-demand periods, and has a storage capacity which will last during a high-demand period when the dewatering MW plant 20 is not operational.

Although MW radiation was used as an example, other electromagnetic radiation may be used. Electromagnetic radiation heats the inherent moisture locked inside the coal particle. When this water is heated, it results in pressure increase inside the coal particle which serves as a driving force for the water vapour to escape from each coal particle. On its way to the coal particle's surface, the water vapour may mechanically carry along other water that is locked inside the particle. This process may increase the thermal yield of the radiation, as not all inherent moisture must be evaporated in order to escape from the coal particle. The result is that process conditions are kept at relatively low temperatures and not all the water released from the coal is in the vapour phase. Liquid water may be driven off the coal's surface and away from the housing by mechanical means. The injection of forced air or inert gas 22 serves as a method for the removal of the excess water, but other methods are also possible.

Dewatering tests shown below conducted on low-rank coal such as Powder River Coal by means of high frequency electromagnetic radiation in moderate process conditions proved that the inherent moisture can be reduced to levels of 1-2% from levels of over 25%. Furthermore, tests showed that the process is also suitable for high-rank coals with initial low inherent moisture of 6-10% which can be reduced to as low as 1%. Also, the EMR of coal proved to conserve its volatile matter content, a critical attribute of coal heat value and its quick burning capability inside a boiler. The process of upgrading solid fossil fuels by EMR is rich in process variables that are easy to control such as radiation level, radiation time, particle size and others, factors which make the process easy to control and optimize.

An amount of raw PRB coal was shipped to a laboratory in Haifa, Israel, for initial tests. Samples were treated in a domestic microwave oven with an output power of 900 Watt and frequency of 2,450 MHz. In addition to the treated coal, a sample of raw coal was also analyzed and the following Table 1 is a summary of the tests:

TABLE 1

| | Samples: | | |
|---|---|---|---|
| | Raw [A] | B | C |
| MW Time [min] | | 6.00 | 10.00 |
| Initial weight [gr] | | 418.40 | 427.00 |
| Final weight [gr] | | 346.80 | 336.30 |
| Energy [Watt-hr] | | 90.00 | 150.00 |
| Weight lost [gr] | | 71.60 | 90.70 |
| Percent wt change | | 17.11% | 21.24% |
| gr/kWhr | | 795.56 | 604.67 |
| short tons/MW-hr | | 0.88 | 0.67 |
| Laboratory Analysis: | | | |
| Inherent Moisture | 25.30% | 9.40% | 1.80% |
| Ash | 2.40% | 3.00% | 5.40% |
| Volatile matter | 35.10% | 41.00% | 48.20% |
| Fixed Carbon | 37.20% | 46.60% | 44.60% |
| Total Sulphur | 0.13% | 0.16% | 0.31% |
| Weight loss efficiency | | | |
| Original amount of water [gr] | | 105.8552 | 108.031 |
| Final amount of water [gr] | | 32.60 | 6.05 |
| Water losses [gr] | | 73.26 | 101.98 |
| Actual weight loss [gr] | | 71.60 | 90.70 |
| MJ/Kg | 20.96 | 25.58 | 27.83 |
| Btu/lb | 9011.18 | 10997.40 | 11964.74 |

From the laboratory analysis it is evident that:

loss of weight observed during the physical tests is attributed to reduced inherent moisture of the coal;

treated coal shows different compositions based on the fact that the water was driven out and the sample total mass was reduced;

volatile matter was not affected by the process, which is a major departure from all other inherent moisture drying processes for PRB coal. In fact, the content of volatile matter has increased proportionally to the reduction in inherent moisture.

The laboratory results as indicated in the table above have shown that the drying of inherent moisture in PRB coal is not only possible, but the process is also relatively efficient. In addition, tests show that apart from moisture, subjecting any coal to EMR reduces coal impurities that are environmentally contaminators and improve the efficiency of its combustion. Furthermore, if the process is conducted during low electricity demand periods it is also highly economical.

The following Table 2 summarizes the process efficiency:

TABLE 2

| Initial temperature: | 60° | F. |
|---|---|---|
| Boiling point: | 212° | F. |
| Thermodynamics: | | |
| Energy to heat 1.0 lb water | 153.52 | Btu |
| Energy to boil the water (latent heat) | 970.00 | Btu |
| Total energy to heat and evaporate | 1,123.52 | Btu |
| 1.0 lb of water | | |
| Test Results | | |
| Case B | | |
| Amount of water evaporated | 0.16 | lb |
| Energy to evaporate | 307.09 | Btu |
| Total energy to heat and evaporate | 1909.17 | Btu |
| 1.0 lb of water | | |
| Efficiency | 58.8% | |
| Case C | | |
| Amount of water evaporated | 0.225 | lb |
| Energy to evaporate | 511.82 | Btu |
| Total energy to heat and evaporate | 2271.11 | Btu |
| 1.0 lb of water | | |

| | |
|---|---|
| Efficiency | 49.5% |

The electromagnetic radiation technique for drying inherent moisture in coal offers at least the following potential benefits: a relatively simple and inexpensive process at low pressure and temperature, a short residence time in the EMR unit which enables large quantity of coal to be processed on a continuous or semi-continuous basis, a clean and environmentally friendly treatment method, a process that can start up and shutdown easily, a process with a small footprint that could be deployed in a normal utility, a process that makes use of low cost energy to upgrade coal used during high demand periods to produce high cost electricity, a process that yields fuel which will be consumed within a short period of time hence eliminating the problem of spontaneous combustion, a process that is deployed in close proximity to the stage where the coal is pulverized to powder, hence eliminating the problem of coal fines and a solution that can integrate well into the entire power generation process of a utility.

Further tests were carried out on samples of various types of coal, in a variety of upgraded scenarios performed both in “batch mode” and “continuous mode” processes. Analysis was carried out on these samples by the Energy & Environmental Research Center (EERC) and it was observed that the removal of impurities from these samples along with the moisture produces fuel with higher combustion efficiency and lower amount of harmful emissions. Some of the impurities removed from the coal through its subjection to EMR are for example: sulfur (S), mercury (Hg), iron (Fe), ash and the like. Analyses have been carried out on several samples of coal in a variety of upgraded scenarios resulting both from a “batch mode” and “continuous mode” processes. Procedure, properties and results of the tests are presented below:

Test No. 1: “Continuous” mode:

Mode of operation:

Continuous—via belt conveyor.

MW properties:

915 MH at 50 KW.

Coal properties:

Coal type: Black Thunder PRB.

Coal size: −2″+0″.

Total feed—3 tons.

Results

a. Black Thunder PRB

| | | | | | Hg ppm |
|---|---|---|---|---|---|
| Sample | Moisture [%] | C [%] | S [%] | Fe [μg/g] | [μg/g] |
| MC1 | 27.90 | 66.80 | 0.61 | 3939 | 0.1315 |
| (Parent) | | | | | |
| MC2 | 17.00 | 68.10 | 0.50 | 2390 | 0.0921 |
| MC3 | 9.80 | 68.36 | 0.47 | 2151 | 0.0685 |

Heat values ranged from a low of 8,548 Btu/lb for the parent sample to a high of 11,173 Btu/lb for the MC3 sample. Sulfur contents were also reduced from a high of 0.61% in the parent sample to 0.44% in the MC3 sample, which represents a 28% reduction in sulfur content. This sulfur reduction was further backed by the analysis of the SO₂ gas emission, which was decreased in direct proportion to the upgrading level of the coal.

Furthermore, a decrease in the emission of NOx gases has also been observed when burning the upgraded coal samples.

Test No. 2: “batch” mode:

Mode of operation:

Batch—in an EMR installation.

MW properties:

2.45 GHz at 1.2 KW

Coal properties:

Coal types: Black Thunder PRB and Pittsburgh.

Coal size: 1−0″

Total feed—425 g of Black Thunder PRB, and 500 g of Pittsburgh.

Initial temperature:

24° C.

Results

a. Black Thunder PRB:

| | | | | | | Final |
|---|---|---|---|---|---|---|
| | Moisture | | | | | Temp |
| Sample | (%) | C (%) | S (%) | Fe (%) | Hg ppm | (C. °) |
| Parent | 27.2 | 71.8 | 0.60 | 0.526 | 0.171 | 24 |
| 5 minutes | 14.2 | 71.3 | 0.61 | 0.349 | 0.111 | 92 |
| 10 minutes | 3.1 | 71.0 | 0.48 | 0.304 | 0.092 | 110 |

b. Pittsburgh:

| | | | | | | Final |
|---|---|---|---|---|---|---|
| | Moisture | | | | | Temp |
| Sample | (%) | C (%) | S (%) | Fe (%) | Hg ppm | (C. °) |
| Parent | 2.97 | 60.22 | 4.71 | 3.04 | 0.154 | 24 |
| 5 Minutes | 0.41 | 61.45 | 4.33 | 2.65 | 0.143 | 75 |
| 10 Minutes | 0.08 | 61.04 | 4.29 | 2.61 | 0.136 | +110 |

The tests showed that the removal of moisture, as well as such impurities as sulfur, iron, mercury and ash from the coal produces an upgraded fossil fuel which provides a higher Btu/lb heat value, release a lesser amount of contaminants to the atmosphere during combustion and will also reduce wear and tear to various installations involved in burning said fossil fuel.

Although a description of a specific embodiment has been presented, it is contemplated that various changes could be made without deviating from the scope of the present invention. For example, the present method could be modified and used for upgrading other solid fossil fuels than coal. The methods of the present invention may be practiced in a separate fuel-drying utility (not producing electric power), the upgraded solid fuel may be traded to other consumers or may be used in other industrial facilities such as cement kilns, furnaces, etc.

1. In an electric power market where consumption of electric power exhibits periods of different demands, a method for managing generated electric power, including
upgrading solid fossil fuel by subjecting it to EMR during periods of low demand using said electric power, and
utilization of said upgraded solid fossil fuel.

2. A method of claim 1, wherein subjecting said fossil fuel to said EMR results in at least the partial removal therefrom of moisture and impurities such as sulfur, ash, iron, mercury and the like.

3. The method of claim 1, wherein said utilization includes one or more of the following: burning said upgraded fossil fuel for electric power generation at least during periods of high demand, burning said upgraded fossil fuel in a heat-consuming industrial process, and trading said upgraded fossil fuel.

4. The method of claim 1, applied by a power-generation plant, wherein said upgrading is performed by means of electric power generated by the same plant.

5. The method of claim 1, further including storing at least part of said upgraded solid fossil fuel.

6. The method of claim 5, wherein said utilization includes burning said upgraded fossil fuel for electric power generation at the same power-generation plant, at least during periods of high demand.

7. The method of claim 6, wherein the quantity of said upgraded and stored fossil fuel is at least equal to that which is consumed for power generation at the same plant during periods of high demand.

8. The method of claim 7, wherein average daily quantity of said upgraded and stored fossil fuel is at least equal to that which is daily consumed in the average for power generation at the same plant.

9. The method of claim 2, wherein subjecting said fossil fuel to said EMR includes reducing the inherent moisture content in the upgraded fossil fuel by 30% or more.

10. The method of claim 1, wherein said solid fossil fuel is one or more of the following: low-rank coal, oil shale, tar sand, and other types of coal.

11. A method of upgrading solid fossil fuel for burning in an industrial process, including subjecting of said solid fossil fuel to Electromagnetic Radiation (EMR), and daily quantity of upgraded fossil fuel obtained thereby is commensurate to daily consumption in said industrial process.

12. A method of claim 11, wherein subjecting said fossil fuel to said EMR results in at least a partial removal therefrom of moisture and impurities such as sulfur, ash, iron, mercury or the like.

13. A method of claim 11, wherein subjecting said fossil fuel to said EMR results in the inherent moisture content in the upgraded fossil fuel being reduced by 30% or more.

14. The method of claim 11, wherein subjecting said fossil fuel to EMR is performed by a first energy consumer in an area where electric power consumption due to consumers other than the first exhibits periods of different demands, said subjecting to EMR is performed during low-demand periods of said electric power consumption.

15. The method of claim 11, wherein said subjecting to EMR is carried out by using electric power produced by a power generation plant burning said fossil fuel in the upgraded state.

16. The method of claim 15, wherein said power generation plant operates with daily peaks of electric power production for external consumers and said subjecting to EMR is performed predominantly during off-peak hours of said electric power production.

17. The method of claim 11, wherein said solid fossil fuel is one or more of the following: low-rank coal, oil shale, tar sand, and other types of coal.

18. The method of claim 11, wherein said subjecting to EMR is preceded by drying in hot gases.

19. The method of claim 11, wherein the EMR is performed by microwave radiation.

20. The method of claim 11, wherein said industrial process is power generation in a plant operating with daily peaks of electric power production for external consumers in the retail market, said subjecting to EMR is performed predominantly during off-peak hours of said electric power production, and using electric power produced by the same power generation plant.

21. The method of claim 11, wherein said upgraded solid fossil fuel is stored in closed containers and said containers are purged with inert gases to prevent ignition.

22. The method of claim 11, wherein said solid fossil fuel is reduced to predetermined size before its subjection to EMR.

23. The method of claim 11, wherein the EMR is performed in one or more stages, at least one stage being directed to driving out inherent moisture.

24. The method of Claim 11, wherein the EMR is performed at least in part in the presence of an inert gas.

25. Upgraded solid fossil fuel obtained by the method of claim 11.

26. A method of upgrading solid fossil fuel for burning in an industrial process, including subjecting said solid fossil fuel to Electromagnetic Radiation (EMR), wherein said EMR is performed by a first energy consumer in an area where electric power consumption due to consumers other than the first exhibits periods of different demands, said EMR is performed during low-demand periods of said electric power consumption.

27. A method of upgrading solid fossil fuel for burning in a power generation plant, including subjecting said solid fossil fuel to Electromagnetic Radiation (EMR), wherein said EMR and said burning are performed at the same power generation plant.

28. A method in claim 27, wherein subjecting said fossil fuel to said EMR results in at least a partial removal therefrom of moisture and impurities such as sulfur, ash, iron, mercury or the like.

29. The method of claim 27, wherein said subjecting to EMR includes reducing the inherent moisture content in the upgraded fossil fuel by 30% or more.

30. A system for energy production by burning solid fossil fuel in a power generation plant including burners, the system comprising
an EMR plant for upgrading said solid fossil fuel, adapted to reduce inherent moisture content in the upgraded solid fossil fuel by 30% or more; and
transportation means for moving the upgraded solid fossil to said burners.

31. The system of claim 34, further comprising storage means suitable to store a quantity of said upgraded solid fossil fuel at least commensurate to daily consumption of said power generation plant.

32. A system for producing upgraded solid fossil fuel for burning in an industrial process, the system comprising
an EMR plant adapted to reduce inherent moisture content in the upgraded solid fossil fuel by 30% or more; and
storage means suitable to store a quantity of said upgraded solid fossil fuel at least commensurate to daily consumption of said industrial process.

33. The system of claim 35, wherein said industrial process is power generation.

34. A system for producing upgraded solid fossil fuel, comprising an EMR plant adapted to reduce inherent moisture content in the upgraded solid fossil fuel by 30% or more, wherein said EMR plant is adapted to process one of the following: low-rank coals, oil shale, tar sand, and other types of coal.
